(19) United States
(12) Patent Application Publication
(10) Pub. No.: US 2012/0164269 A1
(43) Pub. Date: Jun. 28, 2012

(54) Composition for making deer antler wine, method for making deer antler wine by using the composition, and deer antler wine made by the method

(75) Inventors: Eve Szu-Ju Chen, Diamond Bar, CA (US); David Hsiao-Lin Hsu, Diamond Bar, CA (US)

(73) Assignee: Eve Szu-Ju CHEN, Diamond Bar, CA (US)

(21) Appl. No.: 13/064,162

(22) Filed: Mar. 9, 2011

(30) Foreign Application Priority Data
Dec. 22, 2010 (TW) 099145187

(51) Int. Cl. C12G 1/00; C12G 1/022

(52) U.S. Cl. 426/15; 426/615; 426/62; 426/592

(57) ABSTRACT

A composition for making a deer antler wine is disclosed, which includes: a deer antler powder in an amount of 6-24 parts by weight; grapes in an amount of 15.5-62 parts by weight; tea in an amount of 4.5-18 parts by weight; and a ginseng in an amount of 6-24 parts by weight. A method for making a deer antler wine and a deer antler wine made thereby are also disclosed.

### BACKGROUND OF THE INVENTION

1. Field of the Invention

The present invention relates to a composition for making a deer antler wine, a method for making a deer antler wine, and a deer antler wine and, more particularly, to a composition for making a deer antler wine, a method for making a deer antler wine by using the composition, and a deer antler wine made by the method.

2. Description of Related Art

Deer antlers are non-calcified antlers on the heads of the most deer. In many countries, deer antlers are used as medicines, or tonics having particular effects of medication. In accordance with many clinical experiences, extracts of deer antlers possess a large amount of proteins, peptides, and other high-molecular-weight components to decrease blood pressure, increase immunity, delay aging, inhibit inflammation, and enhance sexual performance and vital activity, etc.

So far, it is known that during the rapid growing period of the deer, nutritional components are considerably concentrated in the deer antlers. Furthermore, the rapid-growing time period is also the best timing for harvesting deer antlers. Generally, deer antlers come off the heads automatically every year. The come-off antlers are cut into slices, air-dried outdoors at 60° C. for about 40 days, and then ground into the powder for industrial use. However, the process consumes a lot of time, and proceeds with low efficiency. Moreover, germs or other impurities often contaminate the products in the processes. Therefore, it is difficult to maintain the quality of the products, and to ensure their effects of medication at the same time.

To overcome the disadvantages illustrated above, an alternative process is applied in the related industry. In this alternative process, deer antlers are immersed in alcohol with or without water, and sealed for storage for weeks or even months. Apparently, this process also consumes considerable time, and increases cost for additional sealing for the deer antlers immersed in alcohol to prevent possible oxidation, deterioration, or contamination of the alcohol.

Accordingly, there is a need for a novel method of making a deer antler wine in the current industry to ensure desired effects of medication of the afforded deer antler wine and no contamination of germs or impurities during the production. Moreover, sterilization can be achieved completely to meet sanitary requirements of foods.

### SUMMARY OF THE INVENTION

The object of the present invention is to provide a composition for making a deer antler wine and the composition is used as a medium for fermentation to make the deer antler wine.

Another object of the present invention is to provide a method for making a deer antler wine. In the method, the composition mentioned above is fermented by the yeast to make the deer antler wine. Therefore, this method is a novel method for making the deer antler wine.

Another object of the present invention is to provide a deer antler wine to enhance deer antlers in the improvement of sexual performance of males.

To achieve the object, one aspect of the present invention provides a composition for making a deer antler wine. The composition includes: powder of deer antlers in an amount of 6 to 24 parts by weight; grapes in an amount of 15.5 to 62 parts by weight; tea in an amount of 4.5 to 18 parts by weight; and a ginseng in an amount of 6 to 24 parts by weight.

The abovementioned composition can further include: yeast in an amount of 0.1 to 3.5 parts by weight and water in an amount of 14 to 56 parts by weight.

In the abovementioned composition, the yeast is preferably in an amount of 0.1 to 3 parts by weight, the powder of deer antlers is preferably in an amount of 9 to 14 parts by weight, the grapes are preferably in an amount of 29 to 34 parts by weight, the tea is preferably in an amount of 5 to 10 parts by weight, the ginseng is preferably in an amount of 11 to 15 parts by weight, and the water is preferably in an amount of 18 to 40 parts by weight.

Another aspect of the present invention provides a method for making a deer antler wine. The method includes the following steps: (a) mixing powder of deer antlers, grapes, tea, a ginseng, and hot water in a primary fermenter to form a mixture, wherein the powder of the deer antlers is in an amount of 6 to 24 parts by weight, the grapes are in an amount of 15.5 to 62 parts by weight, the tea is in an amount of 4.5 to 18 parts by weight, the ginseng is in an amount of 6 to 24 parts by weight, and the hot water is in an amount of 14 to 56 parts by weight; (b) adding yeast in an amount of 0.1 to 3.5 parts by weight for first fermentation; and (c) removing dregs of the mixture to obtain a fermented broth and placing the fermented broth in a secondary fermenter for second fermentation to give a deer antler wine.

In the step (a) of the method mentioned above, the yeast is preferably in an amount of 0.1 to 3 parts by weight, the powder of deer antlers is preferably in an amount of 9 to 14 parts by weight, the grapes are preferably in an amount of 29 to 34 parts by weight, the tea is preferably in an amount of 5 to 10 parts by weight, the ginseng is preferably in an amount of 11 to 15 parts by weight, and the water is preferably in an amount of 18 to 40 parts by weight. The specific gravity of the mixture is preferably in a range from 1.09 to 1.16. Meanwhile, the powder of the deer antlers can be boiled for 20 to 30 minutes, selectively. Besides, the powder of the deer antlers can be formed by grinding fresh deer antlers. Before being grinding, the fresh deer antlers can be selectively rinsed. The temperature of the hot water can be in a range from 50 to 100° C., but preferably in a range from 80 to 100° C.

In the step (b) of the method mentioned above, the mixture is preferably stirred during the first fermentation to increase the level of oxygen in the mixture. The first fermentation is performed preferably until the specific gravity of the mixture is 1.02 or less.

The step (b) of the method mentioned above can further include the following step (b1): punching down solid components floating on the surface of the mixture during the first fermentation.

In the step (c) of the method mentioned above, the second fermentation is preferably anaerobic fermentation and the second fermentation is performed preferably until specific gravity of the fermented broth is in a range from 0.998 to 0.97.

In the method depicted above, the step (c) can further include the following step (c1): performing the second fermentation again.

Still another aspect of the present invention provides a deer antler wine, which is made by a method including the following steps: (a) mixing powder of deer antlers, grapes, tea, a ginseng, and hot water in a primary fermenter to form a mixture, wherein the powder of the deer antlers is in an amount of 6 to 24 parts by weight, the grapes are in an amount of 15.5 to 62 parts by weight, the tea is in an amount of 4.5 to 18 parts by weight, the ginseng is in an amount of 6 to 24 parts by weight, and the hot water is in an amount of 14 to 56 parts by weight; (b) adding yeast in an amount of 0.1 to 3.5 parts by weight for first fermentation; and (c) removing dregs of the mixture to obtain a fermented broth and placing the fermented broth in a secondary fermenter for second fermentation to give a deer antler wine.

In the deer antler wine said above, the level of alcohol is preferably in a range from 10% to 15%.

In addition, the yeast used above is preferably wine yeasts, for example Saccharomyces cerevisia.

The aforesaid deer antler wine can be used to increase the level of testosterone so that the sexual performance of males can be promoted. Besides, the deer antler wine can be used alone or in combination with other components to increase the level of testosterone.

In the deer antler wine of the present invention, the deer antlers can combine with other components to achieve synergistic effects and thus the effects of medication thereof are enhanced to increase the level of testosterone in males. Furthermore, since the deer antler wine of the present invention can assimilate efficiently in humans, it can exhibit a better effect on improving sexual performance than commercially available products.

Other objects, advantages, and novel features of the invention will become more apparent from the following detailed description when taken in conjunction with the accompanying drawings.

### BRIEF DESCRIPTION OF THE DRAWINGS

None.

### DETAILED DESCRIPTION OF THE PREFERRED EMBODIMENT

In the composition for making a deer antler wine in the present invention, the components and the percent by weight thereof are shown in the following Table 1.

TABLE 1

| Components | Amount (% wt) |
|---|---|
| Deer antler powder | 9-14% |
| Red grapes | 29-34% |
| Tea | 5-10% |
| Ginseng | 11-15% |
| Water | 18-40% |

In addition to the components listed above, other components can be further added therein. Besides, the source of the components listed above is not limited to those described in the following example. Other sources can be used as long as they can achieve the efficacy of the present invention.

In the method of the present invention, fresh deer antlers are used. The fresh deer antlers are rinsed, ground into powder, and then boiled by heating selectively.

The powder of the deer antlers mentioned above is mixed with boiling water and other components listed in Table 1, and then placed in a sterilized primary fermenter. After the temperature of the mixture decreases to room temperature, the specific gravity thereof is measured and then adjusted to 1.090-1.160 by adding the components listed in Table 1. Yeast is added in a proper amount for first fermentation. During the first fermentation, the mixture is stirred to increase the level of oxygen therein and dissipate the heat therein.

Solids formed on the surface of the mixture during the first fermentation are punched down when the mixture is stirred so that the components in the solids can be introduced in the first-fermented mixture. After the specific gravity of the mixture reaches 1.020 or less, free run wine from the first-fermented mixture is collected in a sterilized secondary fermenter. In addition, the dregs of the mixture are pressed to give press win and the press win is combined with the free run wine in the secondary fermenter. Then, the second fermentation is performed anaerobically.

After the specific gravity of the second-fermented wine reaches about 0.998 to 0.995, the wine is collected in a sterilized container. The collected wine is anaerobically fermented again and then stored in another sterilized container so as to give the deer antler wine of the present invention.

Because of the specific embodiments illustrating the practice of the present invention, one skilled in the art can easily understand other advantages and efficiency of the present invention through the content disclosed therein. The present invention can also be practiced or applied by other variant embodiments. Many other possible modifications and variations of any detail in the present specification based on different outlooks and applications can be made without departing from the spirit of the invention.

### Example

First, fresh New Zealand deer antlers are ground into powder. Before being ground, the fresh New Zealand deer antlers can be rinsed. In addition, the powder of the ground deer antlers can be selectively boiled for 20 to 30 minutes.

The deer antler powder (12 g), boiled water (28 g), red grapes (31 g, from Pinot Noir, France), green tea (9 g, leaves), and American ginsengs (12 g) are mixed to form a mixture and placed in a sterilized primary fermenter.

After the mixture cools to room temperature, the specific gravity thereof is measured with a hydrometer. Adding cool pure water and/or the abovementioned materials (i.e. deer antler powder, red grape, green tea, American ginsengs, etc.) adjusts the specific gravity of the mixture to a range between 1.090 and 1.160. Then, wine yeast (Saccharomyces cerevisia) is added in a suitable amount for first fermentation.

During the first fermentation, the mixture is stirred to increase the level of oxygen therein and to dissipate the heat accumulated. In addition, if solids are formed on the surface of the mixture during the first fermentation, they are punched down when the mixture is stirred. Hence, the components in the solids can be introduced in the mixture. After the specific gravity of the mixture reaches 1.020 or less, the first fermentation is completed.

Subsequently, free run wine from the first-fermented mixture is collected in a sterilized secondary fermenter. After the free run wine is collected, the dregs of the mixture are pressed to give press win and the press win is combined with the free run wine in the secondary fermenter. Then, the second fermentation is performed anaerobically.

During the second fermentation, the specific gravity of the combined wine reaches about 0.998 to 0.995, and then the wine is collected in a sterilized container. The collected wine is anaerobically fermented again and then stored in another sterilized container so as to give the deer antler wine of which alcohol concentration is about 10% to 15%.

### Test Example

The deer antler wine made in Example depicted above is orally administered to ten men (6 oz./day/person). The testosterone levels of the ten men are checked before or after the deer antler wine of Example 1 is taken.

The results show that, compared with before the deer antler wine is taken, five men have an increase of 20-30% and two men have an increase of 15-20% in the testosterone level within three days after the deer antler wine is taken.

Accordingly, although deer antlers have been reported about enhancement of sexual performance, the deer antler wine of the present invention has dramatically better effects than those of the deer antlers recorded in the reports. In other words, because the components in the deer antlers, tea, and ginsengs and resveratrol in the red grapes are combined together to give synergistic effects, enhancement of the sexual performance by the deer antler wine of the present invention can be increased.

In addition to the synergistic effects described above, the fermented deer antler wine of the present invention is advantageous to assimilation by human bodies and the components in the deer antler wine can completely give their effects.

Although the present invention has been explained in relation to its preferred embodiment, it is to be understood that many other possible modifications and variations can be made without departing from the scope of the invention as hereinafter claimed.

What is claimed is:

1. A composition for making a deer antler wine, comprising:
powder of deer antlers in an amount of 6 to 24 parts by weight;
grapes in an amount of 15.5 to 62 parts by weight;
tea in an amount of 4.5 to 18 parts by weight; and
a ginseng in an amount of 6 to 24 parts by weight.

2. The composition as claimed in claim 1, further comprising: yeast in an amount of 0.1 to 3.5 parts by weight and water in an amount of 14 to 56 parts by weight.

3. The composition as claimed in claim 2, wherein the yeast is in an amount of 0.1 to 3 parts by weight, the powder of deer antlers is in an amount of 9 to 14 parts by weight, the grapes are in an amount of 29 to 34 parts by weight, the tea is in an amount of 5 to 10 parts by weight, the ginseng is in an amount of 11 to 15 parts by weight, and the water is in an amount of 18 to 40 parts by weight.

4. A method for making a deer antler wine, comprising the following steps:
(a) mixing powder of deer antlers, grapes, tea, a ginseng, and hot water in a primary fermenter to form a mixture, wherein the powder of the deer antlers is in an amount of 6 to 24 parts by weight, the grapes are in an amount of 15.5 to 62 parts by weight, the tea is in an amount of 4.5 to 18 parts by weight, the ginseng is in an amount of 6 to 24 parts by weight, and the hot water is in an amount of 14 to 56 parts by weight;
(b) adding yeast in an amount of 0.1 to 3.5 parts by weight for first fermentation; and
(c) removing dregs of the mixture to obtain a fermented broth and placing the fermented broth in a secondary fermenter for second fermentation to give a deer antler wine.

5. The method as claimed in claim 4, wherein in the step (a), the yeast is in an amount of 0.1 to 3 parts by weight, the powder of deer antlers is in an amount of 9 to 14 parts by weight, the grapes are in an amount of 29 to 34 parts by weight, the tea is in an amount of 5 to 10 parts by weight, the ginseng is in an amount of 11 to 15 parts by weight, and the water is in an amount of 18 to 40 parts by weight.

6. The method as claimed in claim 4, wherein in the step (a), the specific gravity of the mixture is in a range from 1.09 to 1.16.

7. The method as claimed in claim 4, wherein in the step (b), the mixture is stirred during the first fermentation to increase the level of oxygen in the mixture.

8. The method as claimed in claim 4, wherein the step (b) further comprises the following step (b1): punching down solid components floating on the surface of the mixture during the first fermentation.

9. The method as claimed in claim 4, wherein in the step (b), the first fermentation is performed until the specific gravity of the mixture is 1.02 or less.

10. The method as claimed in claim 4, wherein in the step (c), the second fermentation is anaerobic fermentation.

11. The method as claimed in claim 4, wherein in the step (c), the second fermentation is performed until specific gravity of the fermented broth is in a range from 0.998 to 0.97.

12. The method as claimed in claim 4, wherein the step (c) further comprises the following step (c1): performing the second fermentation again.

13. A deer antler wine, which is made by a method comprising the following steps:
(a) mixing powder of deer antlers, grapes, tea, a ginseng, and hot water in a primary fermenter to form a mixture, wherein the powder of the deer antlers is in an amount of 6 to 24 parts by weight, the grapes are in an amount of 15.5 to 62 parts by weight, the tea is in an amount of 4.5 to 18 parts by weight, the ginseng is in an amount of 6 to 24 parts by weight, and the hot water is in an amount of 14 to 56 parts by weight;
(b) adding yeast in an amount of 0.1 to 3.5 parts by weight for first fermentation; and
(c) removing dregs of the mixture to obtain a fermented broth and placing the fermented broth in a secondary fermenter for, second fermentation to give a deer antler wine.

14. The deer antler wine as claimed in claim 13, wherein the level of alcohol is in a range from 10% to 15%.

15. The deer antler wine as claimed in claim 13, which is used to increase the level of testosterone.
